(19) United States
(12) Patent Application Publication
(10) Pub. No.: US 2026/0275141 A1
(43) Pub. Date: Sep. 17, 2026

(54) ADDITIVE FOR INVISIBLE FLEXOGRAPHIC INKS

(71) Applicant: NOCOPI TECHNOLOGIES, INC., King of Prussia, PA (US)

(72) Inventors: Terry STOVOLD, Conshohocken, PA (US); Karen JOSEPH, Clifton Heights, PA (US)

(73) Assignee: NOCOPI TECHNOLOGIES, INC., King of Prussia, PA (US)

(21) Appl. No.: 19/080,837

(22) Filed: Mar. 15, 2025

(51) Int. Cl. C09D 11/50; C09D 11/17

(52) U.S. Cl. CPC C09D 11/50; C09D 11/17

(57) ABSTRACT

An ink additive for enhancing stability and color change properties of water-based flexographic ink. The ink additive includes a color developer, an antibacterial agent, a wetting and grinding agent, a first binder, a second binder, a wetting agent and evaporation retardant, a wax emulsion and dispersant, and distilled water. The color developer ranges from about 5% to about 25% by weight of the ink additive. The antibacterial agent ranges from about 0.009% to about 2% by weight of the ink additive. The wetting and grinding agent ranges from about 0.01% to about 2% by weight of the ink additive. The first binder ranges from about 1% to about 5% by weight of the ink additive. The second binder ranges from about 0.35% to about 2% by weight of the ink additive. The wetting agent and evaporation retardant ranges from about 3% to about 10% by weight of the ink additive. The wax emulsion and dispersant ranges from about 3% to about 10% by weight of the ink additive, and the distilled water ranges from about 50% to about 90% by weight of the ink additive.

### FIELD

This application relates generally to ink compositions, and more specifically, to an additive for water-based inks to minimize water loss while printing in hot and humid environments.

### BACKGROUND

Invisible inks, such as scratch inks, have been utilized on documents for security and anti-counterfeiting purposes, to create games and other entertainment items such as toys, puzzles and coloring books, and to create notes on a document. A scratch ink includes any ink or material that produces a color change or color initiation by rubbing, scratching, wiping, applying pressure or other heat producing actions.

An example of an invisible ink is disclosed in Applicant's commonly owned U.S. Pat. No. 8,053,494 B2 entitled “Invisible Ink and Scratch Pad,” the entire disclosure of which is incorporated herein by reference. The invisible ink includes two parts—a first part containing a color developer activator and a second part containing a color former leuco dye. These two parts are combined into a water-based ink prior to printing on, for example, a standard flexographic printing press or other conventional printing processes (e.g., gravure, stamping, coating, tint unit, lithographic, etc.). Once printed on a printing medium, the invisible ink dries, and the leuco dye and activator materials will change the color of the printing medium upon the application of heat caused by friction associated with rubbing, scratching or wiping of the ink on the printing medium. Different colors may appear depending on the leuco dye in the ink.

Most water-based inks, including the invisible ink disclosed in U.S. Pat. No. 8,053,494 B2, are prone to water loss while printing in very hot and/or humid environments (e.g., exceeding 90° F. at press side), which results in increased viscosity of the ink due to evaporation of water in the ink. Increased viscosity of the ink can cause significant printing problems. For some inks, such as the invisible ink disclosed in U.S. Pat. No. 8,053,494 B2, the problem cannot be remedied by adding water to the ink to replace the water loss due to high temperature (evaporation), since doing so would reduce the solids within the ink and adversely impact the desired result of the ink being scratched (mechanical pressure and heat resulting from fiction) to cause a color change.

### SUMMARY

In one aspect of this disclosure, an ink additive for enhancing the stability and color change properties of water-based flexographic ink is disclosed. The ink additive includes a color developer, an antibacterial agent, a wetting and grinding agent, a first binder, a second binder, a wetting agent and evaporation retardant, a wax emulsion and dispersant, and distilled water. The color developer ranges from about 5% to about 25% by weight of the ink additive. The antibacterial agent ranges from about 0.009% to about 2% by weight of the ink additive. The wetting and grinding agent ranges from about 0.01% to about 2% by weight of the ink additive. The first binder ranges from about 1% to about 5% by weight of the ink additive. The second binder ranges from about 0.35% to about 2% by weight of the ink additive. The wetting agent and evaporation retardant ranges from about 3% to about 10% by weight of the ink additive. The wax emulsion and dispersant ranges from about 3% to about 10% by weight of the ink additive, and the distilled water ranges from about 50% to about 90% by weight of the ink additive.

In another aspect, a method of manufacturing an ink additive for enhancing the stability and color change properties of water-based flexographic ink is disclosed. The method includes solubilizing at least two binders in distilled water by mixing distilled water at low speed with a wetting agent, antibacterial agent and propylene glycol to form a first mixture, adding a first binder to the first mixture at low speed and mixing until solubilized to form a first binder mixture, and adding a second binder to the first binder mixture at low speed and increasing the speed until the first and second binders are fully solubilized to form a binder mix. A color developer activator is added to the binder mix at high speed to form a color developer activator/binder mix mixture, which is passed through a wet micronizer machine to achieve a particle size with a mean of about 1 micron to about 3 microns, to form a binder mix with micronized color developer activator. A wax emulsion and dispersant is added to the binder mix with micronized color developer activator.

In another aspect, an improved invisible ink that displays color in response to heat, includes a first ink combined with a second ink and an ink additive. The first ink includes a color developer activator without a color former leuco dye in an amount of from about 30% to about 40% by weight of the first ink, a binder in an amount of from about 2% to about 15% by weight of the first ink, one or more components selected from the group consisting of a dispersant and a wetting agent, the one or more components being present in an amount of from about 1% to about 5% by weight of the first ink, the remainder of the first ink being water. The second ink includes a color former leuco dye without a color developer activator in an amount of from about 30% to about 40% by weight of the second ink, a binder in an amount of from about 2% to about 15% by weight of the second ink, one or more components selected from the group consisting of a grind aid, a dispersant and a defoamer, the one or more components being present in an amount of from about 1% to about 5% by weight of the second ink, the remainder of the second ink being water. The ink additive includes a color developer activator in an amount from about 5% to about 25% by weight of the ink additive, an antibacterial agent in an amount from about 0.009% to about 2% by weight of the ink additive, a wetting and grinding agent in an amount from about 0.01% to about 2% by weight of the ink additive, a first binder in an amount from about 1% to about 5% by weight of the ink additive, a second binder in an amount from about 0.35% to about 2% by weight of the ink additive; a wetting agent and evaporation retardant in an amount from about 3% to about 10% by weight of the ink additive, a wax emulsion and dispersant in an amount from about 3% to about 10% by weight of the ink additive, and distilled water in an amount from about 50% to about 90% by weight of the ink additive.

In another aspect, a method of preparing an improved invisible ink that displays color in response to heat is disclosed. The method includes combining a first ink, a second ink and an ink additive prior to color development. The first ink includes a color developer activator without a color former leuco dye in an amount of from about 30% to about 40% by weight of the first ink, a first ink binder in an amount of from about 2% to about 15% by weight of the first ink, one or more components selected from the group consisting of a dispersant and a wetting agent, the one or more components being present in an amount of from about 1% to about 5% by weight of the first ink, the remainder of the first ink being water. The second ink includes a color former leuco dye without a second ink color developer activator in an amount of from about 30% to about 40% by weight of the second ink, a second ink binder in an amount of from about 2% to about 15% by weight of the second ink, one or more components selected from the group consisting of a grind aid, a dispersant and a defoamer, the one or more components being present in an amount of from about 1% to about 5% by weight of the second ink, the remainder of the second ink being water. The ink additive includes a color developer activator, an antibacterial agent, a wetting and grinding agent, a first binder, a second binder, a wetting agent and evaporation retardant, and distilled water.

In another aspect, an improved invisible ink product includes a print medium upon which an improved invisible ink has been applied, wherein heat generated by rubbing and/or scratching the improved invisible ink on the print medium activates a color former leuco dye and activator to change the color on the printing medium. The improved invisible ink includes a first ink combined with a second ink and an ink additive. The first ink includes a color developer activator without a color former leuco dye in an amount of from about 30% to about 40% by weight of the first ink, a binder in an amount of from about 2% to about 15% by weight of the first ink, one or more components selected from the group consisting of a dispersant and a wetting agent, the one or more components being present in an amount of from about 1% to about 5% by weight of the first ink, the remainder of the first ink being water. The second ink includes a color former leuco dye without a color developer activator in an amount of from about 30% to about 40% by weight of the second ink, a binder in an amount of from about 2% to about 15% by weight of the second ink, one or more components selected from the group consisting of a grind aid, a dispersant and a defoamer, the one or more components being present in an amount of from about 1% to about 5% by weight of the second ink, the remainder of the second ink being water. The ink additive includes a color developer activator in an amount from about 5% to about 25% by weight of the ink additive, an antibacterial agent in an amount from about 0.009% to about 2% by weight of the ink additive, a wetting and grinding agent in an amount from about 0.01% to about 2% by weight of the ink additive, a first binder in an amount from about 1% to about 5% by weight of the ink additive, a second binder in an amount from about 0.35% to about 2% by weight of the ink additive, a wetting agent and evaporation retardant in an amount from about 3% to about 10% by weight of the ink additive, a wax emulsion and dispersant in an amount from about 3% to about 10% by weight of the ink additive, and distilled water in an amount from about 50% to about 90% by weight of the ink additive.

In another aspect, an improved invisible ink scratch pad includes a plurality of sheets of paper arranged in a stack. An improved invisible ink is applied to the top surface of each sheet, wherein heat generated by rubbing and/or scratching the invisible ink on the top surface of one of the sheets activates a color former leuco dye and activator to change the color on the sheet. The improved invisible ink includes a color developer activator, a color former leuco dye and an ink additive. The ink additive includes a color developer in an amount from about 5% to about 25% by weight, an antibacterial agent in an amount from about 0.009% to about 2% by weight, a wetting and grinding agent in an amount from about 0.01% to about 2% by weight, a first binder in an amount from about 1% to about 5% by weight, a second binder in an amount from about 0.35% to about 2% by weight, a wetting agent and evaporation retardant in an amount from about 3% to about 10% by weight, a wax emulsion and dispersant in an amount from about 3% to about 10% by weight, and distilled water in an amount from about 50% to about 90% by weight.

These and other advantages of the present disclosure will be apparent to those of ordinary skill in the art by reference to the following detailed description and the accompanying drawings.

### BRIEF DESCRIPTION OF THE DRAWINGS

FIG. 1 is top plan view of a preferred note pad coated with the improved invisible ink; and

FIG. 2 is a side elevational view of the preferred note pad illustrated in FIG. 1.

### DETAILED DESCRIPTION

An invisible ink may be utilized on documents for a variety of purposes, such as a security or anti-counterfeiting mechanism, to create games and other entertainment items, or to create notes on a document.

The invisible ink disclosed in Applicant's commonly owned U.S. Pat. No. 8,053,494 B2 (which is incorporated in its entirety herein by reference) includes two parts—a first part containing a color developer activator and a second part containing a color former leuco dye. These two parts may be combined into a water-based or oil-based ink prior to printing on, for example, a standard flexographic printing press or other conventional printing processes (e.g., gravure, stamping, coating, tint unit, lithographic, etc.). Once printed on a printing medium, the invisible ink dries and the leuco dye and activator materials will change the color of the printing medium upon the application of heat caused by friction associated with rubbing, scratching or wiping of the ink on the printing medium. Different colors may appear depending on the leuco dye in the ink.

The two ink parts described in U.S. Pat. No. 8,053,494 B2 are combined to produce a finished water-based flexographic ink. Unfortunately, most water-based inks are prone to a loss of water while printing under very hot/humid conditions exceeding 90° F. at press side, which increased ink viscosity due to water loss thereby causes significant printing problems. With most other inks, the solution to this problem would be to simply add more water to replace the water lost through evaporation due to high temperatures. However, for the ink disclosed in Applicant's commonly owned U.S. Pat. No. 8,053,494 B2, simply adding more water would reduce the solids, thereby adversely affecting the desired ability to change color when the dried ink is scratched (mechanical pressure and heat caused by friction).

To address this unique problem, an ink additive (“Print Aid”) has been formulated and is disclosed herein. The Print Aid ink additive minimizes the loss of solids, and contains wax and glycol to better address the water loss due to high temperature and humidity conditions present at the press side. The finished ink product will still have an acceptable color change when scratched after being printed on a paper substrate.

Illustrative examples of the finished ink product (i.e., the two-part invisible ink disclosed in Applicant's U.S. Pat. No. 8,053,494 B2 plus the Print Aid ink additive) are described below.

To facilitate production of larger quantities of the invisible ink, processing aids are preferably added to the first and second parts of the invisible ink. Such processing aids include dispersants/surfactants, grind agents, wetting agents and defoamers. Dispersants and surfactants have similar characteristics and are treated the same for purposes of this disclosure.

To avoid premature color activation, it is preferred that the processing aids do not solubilize the leuco dye or activator in the two part ink. Moreover, to avoid hydration of the activator (e.g., D8 (4-hydroxy 4-isopropoxy diphenyl sulfone)), it is preferred that the activator part of the two part ink be effectively dispersed with an appropriate dispersant/surfactant, that each particle be wet out using an appropriate wetting agent, that the particle size be maintained between about 5 microns—about 15 microns, and that the activator part of the ink be stored in a cool area (preferably between about 50° F.-about 60° F.).

Part A Ink of Applicant's U.S. Pat. No. 8,053,494 B2

Examples of activators suitable for use include micronized D8 (4-hydroxy 4-isopropoxy diphenyl sulfone), Bisphenol A available from Sunoco, activating phenolic resins such as zincated, modified alkyphenol activator HRJ-10138, the Alkylphenol Novolac resin activator HRJ-2609 made by Schenectady Chemicals Inc., the chemical zinc chloride ZnCl.sub.2, some bisphenols and hydroxybenzoates, either alone or in combination.

In a preferred embodiment, the activator is preferably wet micronized in water with a binder such as partially or fully hydrolyzed polyvinyl alcohol, an appropriate dispersant/surfactant, and an appropriate wetting agent to an appropriate particle size for the printing method to be utilized. Depending on the printing method, the particle size could be as high as about 25 microns-about 30 microns and as low as about 1 micron or sub-micron. The activator particle size is preferably between about 5 microns and about 15 microns, which has been found to be a particularly effective size to avoid hydration of the activator.

In preparing the activator part of the ink prior to the micronizing process, it is preferred to mix the water, polyvinyl alcohol binder, dispersant/surfactant together in a drum using a high speed mixer before either the wetting agent or activator are added. The wetting agent is then added to the combined water, binder and dispersant and mixed with a high speed mixer for approximately five minutes. The activator is then slowly added to the combined water, binder, dispersant and wetting agent mixture and mixed with a high speed mixer for approximately 30-45 minutes. Alternatively, the wetting agent may be added after the water, binder, dispersant/surfactant and activator are combined together.

An activator (e.g., D8 (4-hydroxy 4-isopropoxy diphenyl sulfone)) is wet micronized in water, partially or fully hydrolyzed polyvinyl alcohol, a dispersant/surfactant and a wetting agent to a particle size of less than about 15 microns. Preferably, the dispersant is an additive capable of dispersing inorganic pigments and solids with low foam, such as Surfynol® 104PG50 manufactured by Air Products and Chemicals, Inc. Preferably, the wetting agent is propylene glycol. Preferably, the activator is from about 30% to about 40% by weight of the Part A ink and most preferably about 32.2%.

The following table sets forth the preferred weight percentage of the ingredients of the exemplary Part A Ink.

| INGREDIENTS | % (wt.) |
|---|---|
| D8 (4-hydroxy 4-isopropoxy diphenyl sulfone) | 32.20 |
| Water | 59.14 |
| Partially hydrolyzed polyvinyl alcohol | 6.96 |
| Dispersant | 0.70 |
| Wetting Agent | 1.00 |

Part B Ink of Applicant's U.S. Pat. No. 8,053,494 B2

Examples of color forming leuco dyes suitable for use include Copikem 14, Copikem Magenta 20, Copikem 6, Copikem 4 made by Hilton-Davis, Pergascript Orange I-5R, Pergascript Red I-6B, Pergascript Green I-3G, Pergascript Yellow I-3R made by Ciga-Geigy, Reakt Red 448, Reakt Yellow 186 made by BASF, Specialty Magenta 20, Specialty Red 747, Specialty Black 34, Specialty Magenta 16, Specialty Orange 14, Specialty Blue 1, Specialty Yellow 37 by Emerald Hilton Davis, or other color formers whether or not synthetic organic coloring matter, either alone or in combination.

Similarly, in the preferred embodiment, the leuco dye is preferably wet micronized in water with a binder such as partially or fully hydrolyzed polyvinyl alcohol, dispersant/surfactant, grinding agent and defoamer, to an appropriate particle size for the printing method to be utilized. Again, depending on the printing method, the particle size could be as high as about 25 microns-about 30 microns and as low as about 1 micron or sub-micron, but the particle size is preferably between about 5-10 microns.

A leuco dye, for example, Specialty Magenta 20, 3, 3-Bis (1-butyl-2-methyl-1H-indol-3-yl)-1-(3H)-isobenzofuranone available from Emerald Hilton Davis in Cincinnati, Ohio is wet micronized in water, partially or fully hydrolyzed polyvinyl alcohol, grind aid, dispersant/surfactant and defoamer to a particle size of less than about 10 microns with a mean around 6-7 microns. Preferably, the grind aid is a solvent-free, nonionic/anionic grind aid designed for aqueous pigment wetting and dispersion, such as Surfynol® CT-131 manufactured by Air Products and Chemicals, Inc. A preferred dispersant is Surfynol® CT-324 manufactured by Air Products and Chemicals, Inc. Preferably, the defoamer is an oil free, nonsilicone defoamer for aqueous systems, such as Surfynol® DF-75 manufactured by Air Products and Chemicals, Inc. The leuco dye is preferably from about 30% to about 40% by weight of the Part B ink and most preferably about 35%.

The following table sets forth the preferred weight percentage of the ingredients of the exemplary Part B Ink.

| INGREDIENTS | % (wt.) |
|---|---|
| Leuco dye | 35.0 |
| Water | 55.3 |
| Partially hydrolyzed polyvinyl alcohol | 6.0 |
| Grind Aid | 1.7 |
| Dispersant | 1.7 |
| Defoamer | 0.3 |

### Print Aid Ink Additive

The Print Aid ink additive may include a color developer activator such as (but not limited to) 4-Hydroxy-4′-isopropoxydiphenylsulfone (“D8”), an antibacterial agent (antimicrobial) such as (but not limited to) an isothiazolinone-based preservative (preferably KATHON™ LX 1.5% biocide manufactured by LANXESS AG), a wetting and grinding aid such as (but not limited to) Surfynol® 104 by Evonik Operations GmbH, a first binder such as (but not limited to) an anionic polyvinyl alcohol (preferably Gohsenol™ L-3266 manufactured by Mitsubishi Chemical Corporation), a second binder such as (but not limited to) partially hydrolyzed polyvinyl alcohol (preferably SELVOL™ 203S available from Sekisui Specialty Chemicals Americas, LLC), a wetting agent and evaporation retardant such as (but not limited to) propylene glycol, a wax emulsion and dispersant such as (but not limited to) Joncryl® 98 wax acrylic emulsion manufactured by BASF Corporation, and distilled water.

The following table sets forth the preferred weight percentage of the ingredients of the exemplary Print Aid ink additive.

| | Preferred | Range |
|---|---|---|
| INGREDIENTS | % (wt.) | % (wt.) |
| D8 (4-Hydroxy-4′-isopropoxydiphenylsulfone) | 11.46 | 5%-25% |
| Antibacterial Agent | 0.017 | 0.009%-2% |
| Wetting And Grinding Agent | 0.035 | 0.01%-2% |
| First Binder | 1.28 | 1%-5% |
| Second Binder | 0.65 | 0.35%-2% |
| Wetting Agent And Evaporation Retardant | 4.35 | 3%-10% |
| Wax Emulsion and Dispersant | 5.15 | 3%-10% |
| Distilled Water | 77.058 | 50%-90% |

The binders (e.g., anionic polyvinyl alcohol (preferably Gohsenol™ L-3266) and partially hydrolyzed polyvinyl alcohol (preferably SELVOL™ 203S)) must be solubilized in the distilled water. Distilled water is used to avoid any changes in pH and to avoid introducing any unnecessary mineral or additives found in common tap water. The distilled water is first mixed at low speed with the wetting agent (e.g., Surfynol® 104), antibacterial agent (e.g., KATHON™ LX 1.5% biocide), and wetting agent and evaporation retardant (e.g., propylene glycol), and then the first binder (e.g., anionic polyvinyl alcohol Gohsenol™ L-3266) is added at low speed and mixed together until solubilized. Then, the second binder (e.g., partially hydrolyzed polyvinyl alcohol SELVOL™ 203S) is added at a low speed, with the speed increased until both binders are fully solubilized (hereinafter referred to as “the Binder Mix”).

Before it can be used in an ink, 4-Hydroxy-4′-isopropoxydiphenylsulfone (“D8”) requires a particle size reduction because large particles of 50-200+ microns will block the cells of the printing aniloxes which will adversely affect the printing quality. Therefore, 4-Hydroxy-4′-isopropoxydiphenylsulfone (“D8”) and the Binder Mix are mixed together at high speed and passed through a standard wet micronizer machine to the desired particle size with a mean of about 1-3 microns (hereinafter referred to as “Binder Mix with Micronized D8”).

Lastly, the wax emulsion and dispersant (e.g., Joncryl® 98 wax acrylic emulsion) is added to the Binder Mix with Micronized D8 to yield the finished Print Aid ink additive, and gives the Print Aid ink additive body and easier laydown on a variety of printing substrates.

The Print Aid ink additive can be added up to about 20% by weight to the two-part ink described in U.S. Pat. No. 8,053,494 B2.

The two-part ink is preferably combined (mixed) at a ratio of the weight of activator (Part A Ink) to leuco dye (Part B Ink) being from about 1:1 to about 8:1. The pH of the combined ink is preferably less than seven. One or more pH adjusters may be used to assure a desirable pH. A pH that is too low (acidic) may cause premature color development.

The Print Aid ink additive can be added up to about 20% by weight to the mixed two-part ink (Finished Part A Ink and Part B Ink). Preferably, the mixed two-part ink (Finished Part A Ink and Part B Ink) is mixed with a high speed mixer to create a vortex in the two-part ink. Once a vortex is created in the ink container of the mixed two-part ink, the Print Aid ink additive is then added (up to about 20% by weight) to the mixed two-part ink and the combined two-part ink and ink additive (Part A, Part B and Print Aid) is mixed for at least five minutes or until all of the Print Aid ink additive is evenly dispersed.

Once printed, the water evaporates and the dry ingredients are left on the substrate or printing medium to be rubbed or scratched to a color change. The color change can vary depending on the leuco dye in the ink. The combined ink is preferably printed as soon as possible after the three parts (Part A, Part B and Print Aid ink additive) have been mixed. The shelf life of the combined ink can be increased to about three months if the three parts are mixed just prior to printing. If the three parts are already mixed, open ink should preferably be used immediately and unopened ink should preferably be used within a month of manufacture of the ink.

The combined ink (Part A, Part B and Print Aid) is printed, preferably immediately, on the appropriate printing medium, substrate or surface (preferably a pH neutral substrate). The new printed ink will rub or scratch to a color change and be less susceptible to premature coloring on acidic or thermal substrates than existing scratch inks.

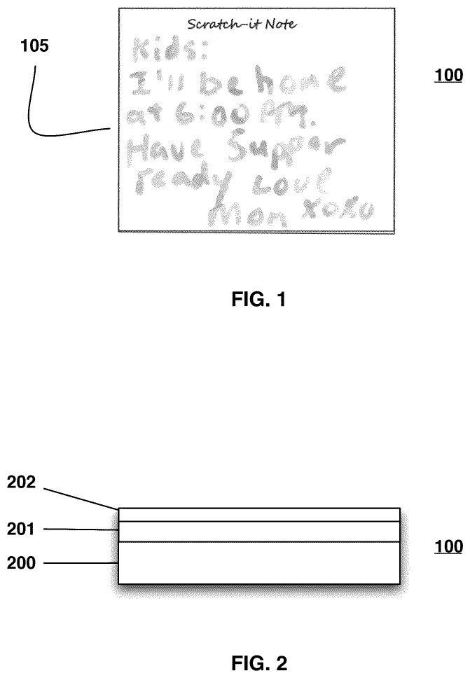

Referring to FIGS. 1 and 2, there is shown an exemplary printing medium, such as a note pad 100, upon which the improved invisible ink (Part A, Part B and Print Aid) disclosed herein may be printed or coated. The note pad 100 can be a single sheet of paper or the like, or multiple sheets assembled into a stack or pad. For example, the note pad 100 can be formed of multiple sheets 200 of paper or the like, with each sheet 200 being releasable from the pad, such as, for instance, using a pressure sensitive adhesive on a portion of the sheet or via tear perforations provided in the sheet.

Preferably, the entire surface of each sheet 200 of the note pad 100 is coated with a layer 201 of the invisible ink described herein. Sharp and clear text and drawings 105 can be created on the note pad 100 by rubbing or scratching the coated surface 201 of the note pad 100 with a writing tool (e.g., a stylus), fingernail or other hard object (not shown) such that frictional heat caused by the movement of the writing tool, fingernail, etc. over the coated surface causes the ink to change color to form the text or drawings 105. Thus, written notes and drawings 105 can be created on the coated sheet 200 without the need for a pen, pencil or other conventional writing instrument. The notes or drawings 105 preferably remain visible on the coated sheet 200 for several days, after which time, they preferably disappear and new notes or drawings can be created on the coated sheet 200. In the preferred embodiment, each coated sheet 200 may be used multiple times (e.g., three to four times) before the invisible ink coating no longer provides sharp and clear images. The sheet 200 may be discarded after that time. In the preferred embodiment, markings can also be created on the sheet 200 using a traditional pen or pencil.

To avoid powdering, a relatively thin layer or top coating 202 of wax or other suitable material may be applied over the layer invisible ink 201 on the printing medium 200. This top coating 202 is preferably a wax-based coating comprising approximately 50% by weight wax and 50% by weight water. The thickness of the top coating 202 is preferably approximately 10%-20% less than the thickness of the layer of combined invisible ink 201 applied to the printing medium 200.

The improved invisible ink (Part A, Part B and Print Aid) described herein can also be used to create novel toys, puzzles, art products, educational, interactive customer verification products, novelty items and games, for example, tic-tac-toe, mazes, matching games, coloring books/pictures, quiz books, hang man games, connect the dots pictures and problem solving games, stickers, decorative items, art projects, gambling items/cards/tickets, etc. These can be implemented in any form. Examples include placemats, cards, single pages of paper or pads of paper or other substrates, plastic films, labels, tags, stickers, various leathers or synthetic materials.

It is understood, however, that the improved invisible ink disclosed herein is not limited to interactive game applications and may be used as an anti-counterfeiting mechanism, to protect against illegal document duplication or as other security mechanisms. A simple rubbing action could verify the authenticity of the item.

Having described and illustrated the principles of this application by reference to one or more preferred embodiments, it should be apparent that the preferred embodiment(s) may be modified in arrangement and detail without departing from the principles disclosed herein and that it is intended that the application be construed as including all such modifications and variations insofar as they come within the spirit and scope of the subject matter disclosed herein.

What is claimed is:

1. An ink additive for enhancing the stability and color change properties of water-based flexographic ink, comprising:
a color developer activator in an amount from about 5% to about 25% by weight;
an antibacterial agent in an amount from about 0.009% to about 2% by weight;
a wetting and grinding agent in an amount from about 0.01% to about 2% by weight;
a first binder in an amount from about 1% to about 5% by weight;
a second binder in an amount from about 0.35% to about 2% by weight;
a wetting agent and evaporation retardant in an amount from about 3% to about 10% by weight;
a wax emulsion and dispersant in an amount from about 3% to about 10% by weight; and
distilled water in an amount from about 50% to about 90% by weight.

2. The ink additive of claim 1, wherein the color developer activator is D8 (4-Hydroxy-4′-isopropoxydiphenylsulfone).

3. The ink additive of claim 2, wherein D8 (4-Hydroxy-4′-isopropoxydiphenylsulfone) is present in an amount of from about 10% to about 15% by weight.

4. The ink additive of claim 1, wherein the antibacterial agent is an isothiazolinone-based preservative.

5. The ink additive of claim 4, wherein the isothiazolinone-based preservative is present in an amount of from about 0.01% to about 0.02% by weight.

6. The ink additive of claim 1, wherein the wetting and grinding agent is present in an amount of from about 0.03% to about 0.04% by weight.

7. The ink additive of claim 1, wherein the first binder is anionic polyvinyl alcohol.

8. The ink additive of claim 7, wherein the anionic polyvinyl alcohol is present in an amount of from about 1% to about 1.5% by weight.

9. The ink additive of claim 7, wherein the second binder is partially hydrolyzed polyvinyl alcohol.

10. The ink additive of claim 9, wherein the partially hydrolyzed polyvinyl alcohol is present in an amount of from about 0.5% to about 1% by weight.

11. The ink additive of claim 1, wherein the wetting agent and evaporation retardant is propylene glycol.

12. The ink additive of claim 11, wherein propylene glycol is present in an amount of from about 4% to about 5% by weight.

13. The ink additive of claim 1, wherein the wax emulsion and dispersant is present in an amount from about 5% to about 6% by weight.

14. The ink additive of claim 1, wherein the distilled water is present in an amount from about 75% to about 80% by weight.

15. A method of manufacturing an ink additive for enhancing the stability and color change properties of water-based flexographic ink, comprising:
solubilizing at least two binders in distilled water by
(i) mixing distilled water at low speed with a wetting agent, antibacterial agent and propylene glycol to form a first mixture,
(ii) adding a first binder to the first mixture at low speed and mixing until solubilized to form a first binder mixture, and
(iii) adding a second binder to the first binder mixture at low speed and increasing the speed until the first and second binders are fully solubilized to form a binder mix;
adding a color developer activator to the binder mix at high speed to form a color developer activator/binder mix mixture, and passing the color developer activator/binder mix mixture through a wet micronizer machine to achieve a particle size with a mean of about 1 micron to about 3 microns, to form a binder mix with micronized color developer activator; and
adding a wax emulsion and dispersant to the binder mix with micronized color developer activator.

16. The method of claim 15, wherein the color developer activator is D8 (4-Hydroxy-4′-isopropoxydiphenylsulfone).

17. The method of claim 15, wherein the first binder is anionic polyvinyl alcohol and the second binder is partially hydrolyzed polyvinyl alcohol.

18. The method of claim 15, wherein the antibacterial agent is an isothiazolinone-based preservative.

19. An improved invisible ink that displays color in response to heat, comprising:
a first ink combined with a second ink and an ink additive;
the first ink comprising a color developer activator without a color former leuco dye in an amount of from about 30% to about 40% by weight of the first ink, a binder in an amount of from about 2% to about 15% by weight of the first ink, one or more components selected from the group consisting of a dispersant and a wetting agent, the one or more components being present in an amount of from about 1% to about 5% by weight of the first ink, the remainder of the first ink being water;
the second ink comprising a color former leuco dye without a color developer activator in an amount of from about 30% to about 40% by weight of the second ink, a binder in an amount of from about 2% to about 15% by weight of the second ink, one or more components selected from the group consisting of a grind aid, a dispersant and a defoamer, the one or more components being present in an amount of from about 1% to about 5% by weight of the second ink, the remainder of the second ink being water; and
the ink additive comprising a color developer activator in an amount from about 5% to about 25% by weight of the ink additive, an antibacterial agent in an amount from about 0.009% to about 2% by weight of the ink additive, a wetting and grinding agent in an amount from about 0.01% to about 2% by weight of the ink additive, a first binder in an amount from about 1% to about 5% by weight of the ink additive, a second binder in an amount from about 0.35% to about 2% by weight of the ink additive; a wetting agent and evaporation retardant in an amount from about 3% to about 10% by weight of the ink additive, a wax emulsion and dispersant in an amount from about 3% to about 10% by weight of the ink additive, and distilled water in an amount from about 50% to about 90% by weight of the ink additive.

20. The improved invisible ink of claim 19, wherein the color developer activator in the ink additive is D8 (4-Hydroxy-4′-isopropoxydiphenylsulfone).

21. The improved invisible ink of claim 19, wherein the antibacterial agent is an isothiazolinone-based preservative.

22. The improved invisible ink of claim 19, wherein the first binder in the ink additive is anionic polyvinyl alcohol.

23. The improved invisible ink of claim 22, wherein the second binder in the ink additive is partially hydrolyzed polyvinyl alcohol.

24. The improved invisible ink of claim 19, wherein the wetting agent and evaporation retardant is propylene glycol.

25. A method of preparing an improved invisible ink that displays color in response to heat, comprising:
preparing a first ink comprising a color developer activator without a color former leuco dye in an amount of from about 30% to about 40% by weight of the first ink, a first ink binder in an amount of from about 2% to about 15% by weight of the first ink, one or more components selected from the group consisting of a dispersant and a wetting agent, the one or more components being present in an amount of from about 1% to about 5% by weight of the first ink, the remainder of the first ink being water;
preparing a second ink comprising a color former leuco dye without a second ink color developer activator in an amount of from about 30% to about 40% by weight of the second ink, a second ink binder in an amount of from about 2% to about 15% by weight of the second ink, one or more components selected from the group consisting of a grind aid, a dispersant and a defoamer, the one or more components being present in an amount of from about 1% to about 5% by weight of the second ink, the remainder of the second ink being water;
preparing an ink additive comprising a color developer activator, an antibacterial agent, a wetting and grinding agent, a first binder, a second binder, a wetting agent and evaporation retardant, and distilled water; and
combining the first ink, the second ink and the ink additive prior to color development.

26. The method according to claim 25, wherein the color developer activator in the ink additive is D8 (4-hydroxy-4′-isopropoxydiphenylsulfone).

27. The method according to claim 26, wherein the color developer activator is present in the ink additive in an amount from about 5% to about 25% by weight of the ink additive.

28. The method according to claim 25, wherein the first binder in the ink additive is an anionic polyvinyl alcohol.

29. The method according to claim 28, wherein the first binder is present in the ink additive in an amount from about 1% to about 5% by weight of the ink additive.

30. The method according to claim 25, wherein the second binder in the ink additive is a partially hydrolyzed polyvinyl alcohol.

31. The method according to claim 30, wherein the second binder is present in the ink additive in an amount from about 0.35% to about 2% by weight of the ink additive.

32. The method according to claim 25, wherein the wetting agent and evaporation retardant in the ink additive is propylene glycol.

33. The method according to claim 32, wherein propylene glycol is present in the ink additive in an amount from about 3% to about 10% by weight of the ink additive.

34. The method according to claim 25, wherein the wetting and grinding aid is present in the ink additive in an amount from about 0.01% to about 2% by weight of the ink additive.

35. The method according to claim 25, wherein the antibacterial agent is present in the ink additive in an amount from about 0.009% to about 2% by weight of the ink additive.

36. The method according to claim 25, wherein the wax emulsion and dispersant is present in the ink additive in the amount of about 3.0% to about 10.0% by weight of the ink additive.

37. The method according to claim 26, further comprising wet micronizing the D8 (4-hydroxy-4′-isopropoxydiphenylsulfone) to a particle size with a mean of about 1 micron to about 3 microns.

38. An improved invisible ink product, comprising:
a print medium upon which an improved invisible ink has been applied;
the improved invisible ink comprising a first ink combined with a second ink and an ink additive;
the first ink comprising a color developer activator without a color former leuco dye in an amount of from about 30% to about 40% by weight of the first ink, a binder in an amount of from about 2% to about 15% by weight of the first ink, one or more components selected from the group consisting of a dispersant and a wetting agent, the one or more components being present in an amount of from about 1% to about 5% by weight of the first ink, the remainder of the first ink being water;
the second ink comprising a color former leuco dye without a color developer activator in an amount of from about 30% to about 40% by weight of the second ink, a binder in an amount of from about 2% to about 15% by weight of the second ink, one or more components selected from the group consisting of a grind aid, a dispersant and a defoamer, the one or more components being present in an amount of from about 1% to about 5% by weight of the second ink, the remainder of the second ink being water;
the ink additive comprising a color developer activator in an amount from about 5% to about 25% by weight of the ink additive, an antibacterial agent in an amount from about 0.009% to about 2% by weight of the ink additive, a wetting and grinding agent in an amount from about 0.01% to about 2% by weight of the ink additive, a first binder in an amount from about 1% to about 5% by weight of the ink additive, a second binder in an amount from about 0.35% to about 2% by weight of the ink additive, a wetting agent and evaporation retardant in an amount from about 3% to about 10% by weight of the ink additive, a wax emulsion and dispersant in an amount from about 3% to about 10% by weight of the ink additive, and distilled water in an amount from about 50% to about 90% by weight of the ink additive; and
wherein heat generated by rubbing and/or scratching the improved invisible ink on the print medium activates the color former leuco dye and activator to change the color on the printing medium.

39. An improved invisible ink scratch pad, comprising:
a plurality of sheets of paper arranged in a stack;
each sheet of paper having a top surface and a bottom surface;
the bottom surface of each sheet having an adhesive applied to at least a portion thereof to releasably secure the sheets of paper to the stack;
the top surface of each sheet having an improved invisible ink applied thereto, the improved invisible ink comprising a color developer activator, a color former leuco dye and an ink additive;
wherein the ink additive comprises a color developer in an amount from about 5% to about 25% by weight, an antibacterial agent in an amount from about 0.009% to about 2% by weight, a wetting and grinding agent in an amount from about 0.01% to about 2% by weight, a first binder in an amount from about 1% to about 5% by weight, a second binder in an amount from about 0.35% to about 2% by weight, a wetting agent and evaporation retardant in an amount from about 3% to about 10% by weight, a wax emulsion and dispersant in an amount from about 3% to about 10% by weight, and distilled water in an amount from about 50% to about 90% by weight, and
wherein heat generated by rubbing and/or scratching the invisible ink on the top surface of one of the sheets activates the color former leuco dye and activator to change the color on the sheet.
